(19) United States
(12) Patent Application Publication
(10) Pub. No.: US 2011/0018449 A1
(43) Pub. Date: Jan. 27, 2011

(54) AC LED device for avoiding harmonic current and flash

(75) Inventors: Pei-Hsuan Lan, Banciao City (TW); Jui-Hung Chen, Taoyuan City (TW); Jen-Hua Yang, Luodong Township (TW); Yu-Bing Lan, Banciao City (TW)

Correspondence Address: BACON & THOMAS, PLLC, 625 SLATERS LANE, FOURTH FLOOR, ALEXANDRIA, VA, 22314-1176, US

(73) Assignee: Forward Electronics Co., Ltd., Taipei City (TW)

(21) Appl. No.: 12/588,328

(22) Filed: Oct. 13, 2009

(30) Foreign Application Priority Data
Jul. 27, 2009 (TW) 098213711

(51) Int. Cl. H05B 37/02

(52) U.S. Cl. 315/185 R; 315/250

(57) ABSTRACT

An AC LED device for avoiding harmonic current and flash includes an AC power input terminal, a first AC LED group and a second AC LED group. The AC power input terminal receives an AC power including a positive half-cycle and a negative half-cycle. The first AC LED group is turned on in the positive half-cycle and turned off in the negative half-cycle. The second AC LED group is turned on in the negative half-cycle and turned off in the positive half-cycle. Each of the first AC LED group and the second AC LED group has an overall on voltage with a value lower than a peak voltage value of the AC power by a predetermined value, and an overall peak inverse voltage with a value higher than the peak voltage value of the AC power, so as to increase power factor and avoid harmonic current, thereby effectively eliminating flash problems of the AC LED.

### BACKGROUND OF THE INVENTION

1. Field of the Invention

The invention relates generally to an AC LED device and, more particularly, to an AC LED device for avoiding harmonic current and flash.

2. Description of Related Art

Light Emitting Diode (LED) is one of the key developments in the recent technology. The processing technique for LED is getting mature gradually, which can produce LEDs with a variety of colors, such as. blue, white, pink, purple, red, orange, green and yellow. The LED is also applied in many lighting products, such as flashlights, automotive lights and decorative lights. In order to expand the application of LED, a new AC LED is developed, which can be directly connected to an AC power of 110V, 60 Hz or higher frequency. The development of AC LED has overcome the problem that LED cannot be powered by AC power directly.

The AC LED is advantageous in being able to connect to the utility power directly. However, if the voltage and current of AC power system become unstable, the brightness of AC LED will be changed significantly, resulting in apparent flash that is likely to be recognized by human eyes. Besides, the AC power has a positive half-cycle and a negative half-cycle. If the overall on voltage of AC LED is too high, it will also generate apparent flash owing to that the AC LED has too much current in zero-crossing zone. Therefore, it is desirable to provide an improved AC LED device to mitigate and/or obviate the aforementioned problems.

### SUMMARY OF THE INVENTION

The object of the present invention is to provide an AC LED device for avoiding harmonic current and flash.

To achieve this object, there is provided an AC LED device for avoiding harmonic current and flash, which comprises: an AC power input terminal for receiving an AC power including a positive half-cycle and a negative half-cycle each having a peak voltage value; a first AC LED group which is turned on in the positive half-cycle and turned off in the negative half-cycle; and a second AC LED group which is turned on in the negative half-cycle and turned off in the positive half-cycle; wherein, each of the first AC LED group and the second AC LED group includes a plurality of LED micro-chips, and each LED micro-chip has an on voltage and a peak inverse voltage, such that each of the first AC LED group and the second AC LED group has an overall on voltage with a value lower than the peak voltage value of the AC power by a predetermined value, and an overall peak inverse voltage with a value higher than the peak voltage value of the AC power, so as to increase power factor.

The AC LED device for avoiding harmonic current and flash in accordance with present invention is able to avoid the generation of harmonic current and effectively eliminate the flash problems of the AC LED by adjusting the overall on voltage of the AC LED groups.

### BRIEF DESCRIPTION OF THE DRAWINGS

FIG. 1(a) schematically illustrates a first AC LED group in accordance with an embodiment of the present invention;

FIG. 1(b) schematically illustrates a second AC LED group in accordance with an embodiment of the present invention;

FIG. 2 illustrates a current-voltage diagram of an AC LED micro-chip;

FIG. 3 illustrates a voltage diagram of an AC LED device in comparison with that of an AC power supply terminal;

FIG. 4(a) illustrates a third AC LED group in accordance with another embodiment of the present invention;

FIG. 4(b) illustrates a forth AC LED group in accordance with another embodiment of the present invention; and

FIG. 5 illustrates a voltage diagram of an AC LED device in comparison with that of an AC power supply terminal.

### DETAILED DESCRIPTION OF THE PREFERRED EMBODIMENT

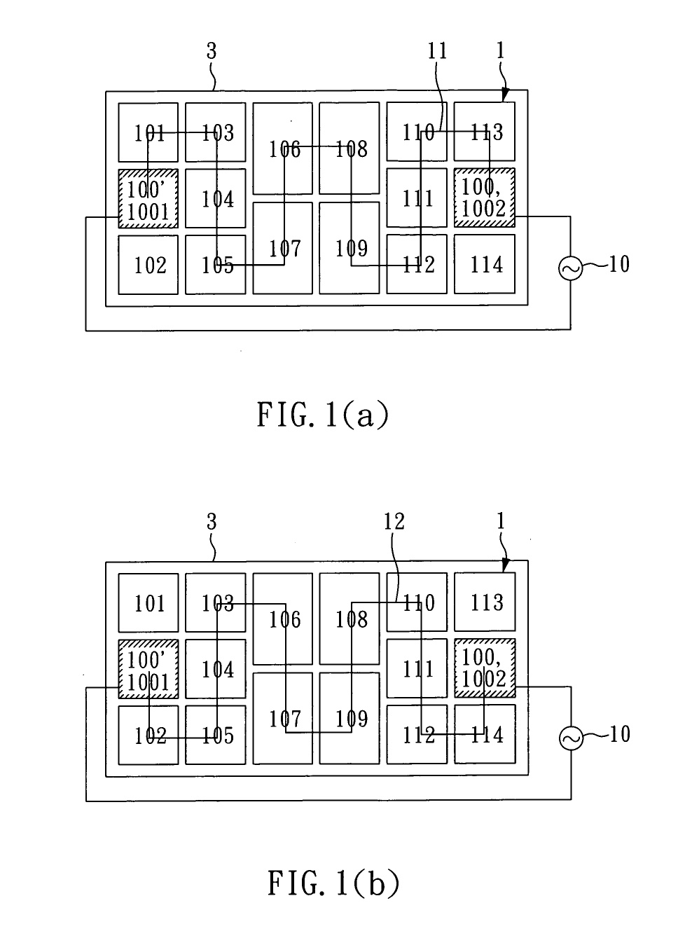

With reference to FIG. 1, there is shown an AC LED device 1 for avoiding harmonic current and flash in accordance with a preferred embodiment of the present invention. The AC LED device 1 includes fourteen LED micro-chips 101-114, and an AC power input terminal 100. The fourteen LED micro-chips 101-114 and the AC power input terminal 100 are integrated into a chip 3 of the same package.

As shown in FIG. 1(a), the LED micro-chips 101, 103, 104, 105, 107, 106, 108, 109, 112, 111, 110 and 113 are connected in series to form a first AC LED group 11. As shown in FIG. 1(b), the LED micro-chips 114, 112, 111, 110, 108, 109, 107, 106, 103, 104, 105 and 102 are connected in series to form a second AC LED group 12. The AC power input terminal 100 has a first input terminal 1001 and a second input terminal 1002. The first input terminal 1001 is connected to a utility power 10 for receiving an AC power including a positive half-cycle and a negative half-cycle each having a peak voltage value. The first AC LED group 11 is turned on in the positive half-cycle and turned off in the negative half-cycle. The second AC LED group 12 is turned on in the negative half-cycle and turned off in the positive half-cycle.

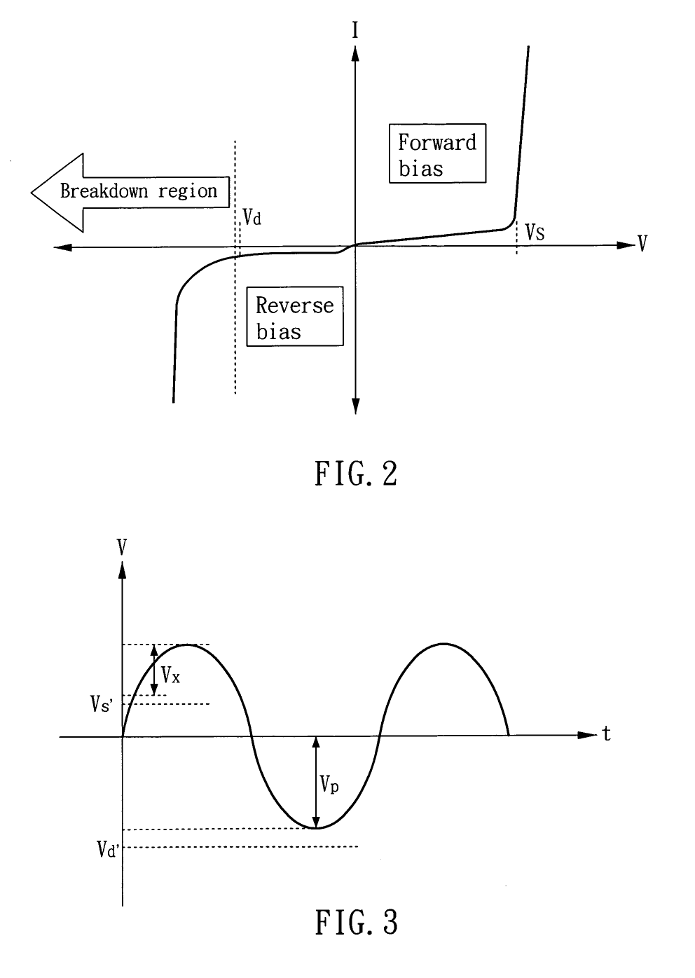

With reference to FIG. 2 and FIG. 3, FIG. 2 shows a voltage-current diagram of the AC LED device, and FIG. 3 shows an overall on voltage and an overall peak inverse voltage of the AC LED device in comparison with an AC power voltage. As shown, each of the LED micro-chips 101-114 has an on voltage Vs and a peak inverse voltage Vd, such that each of the first AC LED group 11 and the second AC LED group 12 has an overall on voltage Vs′ and an overall peak inverse voltage Vd′. The overall on voltage Vs′ is lower than the peak voltage value of the AC power by a predetermined value Vx, and the overall peak inverse voltage Vd′ is higher than the peak voltage value Vp of the AC power so as to increase power factor. That is, when the AC power is unstable, owing to that each of the first AC LED group 11 and the second AC LED group 12 has the overall on voltage Vs′ much lower than the peak voltage value of the AC power (by a predetermined value Vx), each of the LED micro-chips 101-114 that are turned on still has a voltage higher than the on voltage Vs so as not to generate flash. Furthermore, owing to that each of the first AC LED group 11 and the second AC LED group 12 has the overall peak inverse voltage Vd′ higher than the peak voltage value Vp of the AC power, each of the LED micro-chips 101-114 that are turned off can be prevented from burning due to overload.

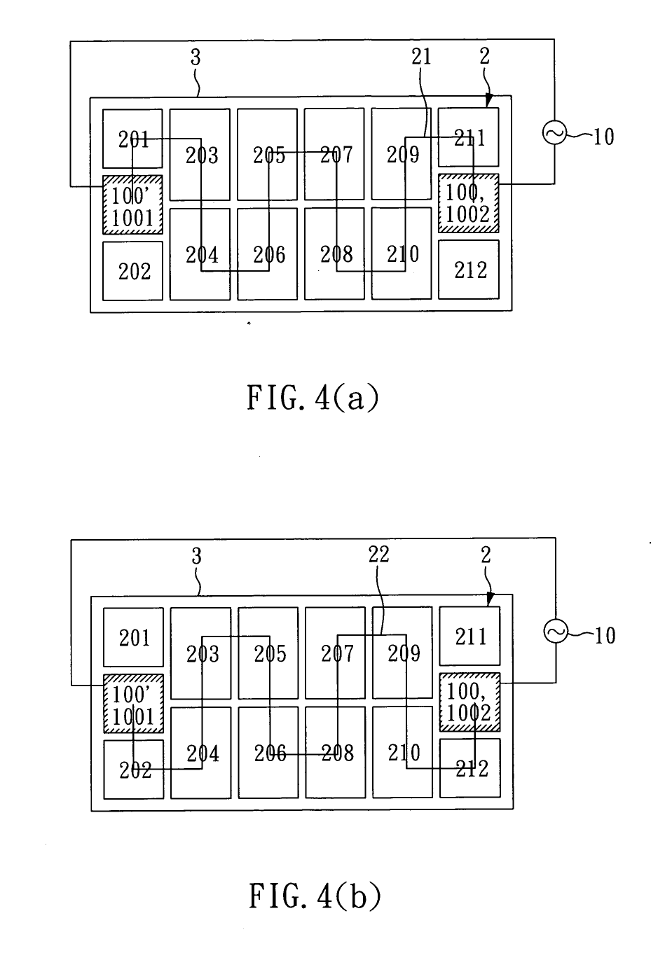

With reference to FIG. 4, there is shown an AC LED device 2 for avoiding harmonic current and flash in accordance with another embodiment of the present invention. The AC LED device 2 includes twelve LED micro-chips 201-212, and an AC power input terminal 100. The twelve LED micro-chips 201-212 and the AC power input terminal 100 are integrated into a chip 3 of the same package. As shown in FIG. 4(a), the LED micro-chip 201, 203, 204, 206, 205, 207, 208, 210, 209 and 211 are connected in series to form a third AC LED group 21. As shown in FIG. 4(b), the LED micro-chip 212, 210, 209, 207, 208, 206, 205, 203, 204 and 202 are connected in series to form a forth AC LED group 22.

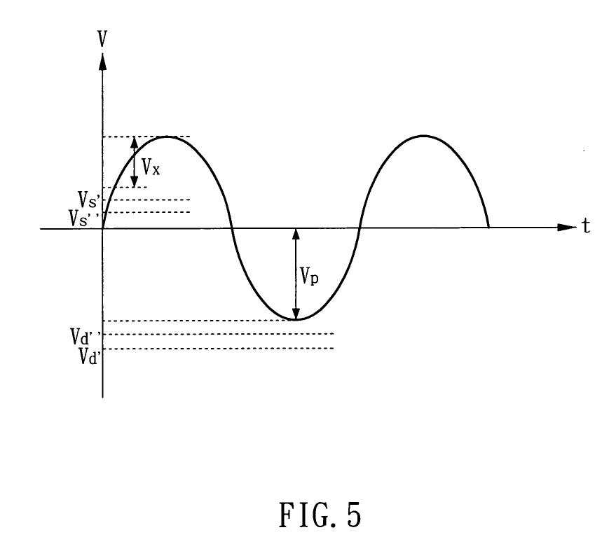

Further, please refer to FIG. 5. As the number of LED micro-chips that are turned on in the third AC LED group 21 and the forth AC LED group 22 is smaller than that in the first AC LED group 11 and the second AC LED group 12, an overall on voltage Vs″ of the third AC LED group 21 and the forth AC LED group 22 is consequentially lower than the overall on voltage Vs′ of the first AC LED group 11 and the second AC LED group 12. If an overall peak inverse voltage Vd″ of the third AC LED group 21 and the forth AC LED group 22 is controlled to be higher than the peak voltage value Vp of the AC power, the power factor of the AC LED device 2 can be more efficiently increased. FIG. 5 shows the overall on voltage Vs″ and the overall peak inverse voltage Vd″ of the third AC LED group 21 and the forth AC LED group 22 in comparison with the AC power voltage.

In view of the foregoing, it is known that the AC LED device for avoiding harmonic current and flash of the present invention is able to avoid the generation of harmonic current and effectively eliminate the flash problems of the AC LED by adjusting the overall on voltage of the AC LED groups.

Although the present invention has been explained in relation to its preferred embodiment, it is to be understood that many other possible modifications and variations can be made without departing from the spirit and scope of the invention as hereinafter claimed.

What is claimed is:

1. An AC LED device for avoiding harmonic current and flash, comprising:
an AC power input terminal for receiving an AC power including a positive half-cycle and a negative half-cycle each having a peak voltage value;
a first AC LED group which is turned on in the positive half-cycle and turned off in the negative half-cycle; and
a second AC LED group which is turned on in the negative half-cycle and turned off in the positive half-cycle;
wherein, each of the first AC LED group and the second AC LED group includes a plurality of LED micro-chips, and each LED micro-chip has an on voltage and a peak inverse voltage, such that each of the first AC LED group and the second AC LED group has an overall on voltage with a value lower than the peak voltage value of the AC power by a predetermined value, and an overall peak inverse voltage with a value higher than the peak voltage value of the AC power so as to increase power factor.

2. The AC LED device for avoiding harmonic current and flash of claim 1, wherein the AC power input terminal, the first AC LED group, and the second AC LED group are integrated into a chip.

3. The AC LED device for avoiding harmonic current and flash of claim 2, wherein the AC power input terminal, the first AC LED group, and the second AC LED group are set in a package structure.

4. The AC LED device for avoiding harmonic current and flash of claim 1, wherein the AC power input terminal is connected to utility power.

5. The AC LED device for avoiding harmonic current and flash of claim 4, wherein the peak voltage value of the utility power is higher than the overall on voltage of each of the first AC LED group and the second AC LED group.

6. The AC LED device for avoiding harmonic current and flash of claim 1, wherein the plurality of LED micro-chips in the first AC LED group are connected in series.

7. The AC LED device for avoiding harmonic current and flash of claim 1, wherein the plurality of LED micro-chips in the second AC LED group are connected in series.
